(19) United States
(12) Patent Application Publication
(10) Pub. No.: US 2005/0030691 A1
(43) Pub. Date: Feb. 10, 2005

(54) Power supply and control method for injector driver module

(75) Inventors: Stephan Bolz, Pfatter (DE); Simon Makar, Macomb Township, MI (US); Larry Hiltunen, Sterling Heights, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/895,632

(22) Filed: Jul. 21, 2004

Related U.S. Application Data
(60) Provisional application No. 60/489,008, filed on Jul. 21, 2003.

(51) Int. Cl. H01H 47/32; F02M 51/00

(52) U.S. Cl. 361/152; 123/490

(57) ABSTRACT

An injector driver module includes a first converter and a second converter connected between a power supply and the load. The first converter generates a first voltage output and the second converter generates a second voltage output from the power supply. Switches control the level of the supply voltage so that the voltage applied to the load can be varied depending on an operational phase of the driver. Control over the current through the load can be therefore be conducted via pulse width modulation at lower voltage levels, thereby lengthening the switching time during modulation, reducing power losses, and reducing EMI emissions.

### REFERENCE TO RELATED APPLICATIONS

The application claims priority to U.S. Provisional Application No. 60/489,008, which was filed on Jul. 21, 2003.

### TECHNICAL FIELD

The present invention relates to a driver module for a fluid injector.

### BACKGROUND OF THE INVENTION

Vehicles use injector driver modules to operate magnetic fuel injectors. Currently known injector drive modules use an injector coil that is activated with short current pulses at a selected current level (e.g., 20A). Because the injector coil is a natural inductor, it requires a high initial voltage to bring the current level in the injector coil to the selected level in a short time period. This high voltage requirement makes a conventional 12V vehicle battery unsuitable for operating the injector coil directly.

To boost the vehicle battery voltage, a DC-DC converter is incorporated to increase the supply voltage for the injector coil to a desired high voltage level (e.g., 48V). This higher supply voltage is then used to supply the injector coil in the injector drive module. The high supply voltage ensures that the current level in the injector coil ramps up quickly, but additional measures need to be taken to control the voltage across the injector coil to a desired average value during the current pulse.

One option is to periodically switch the supply voltage between 48V and ground, thereby controlling the voltage across the injector coil through pulse width modulation. However, rapid on/off switching of such a high supply voltage introduces electromagnetic radiation (i.e., EMI emissions), which causes radio reception interference, particularly in the AM band. Additional structures, such as shields, must therefore be incorporated into the injector drive module or other areas of the vehicle to reduce the interference. Moreover, the high power requirements cause large power losses in the injector driver module.

There is a desire for an injector driver module that does not introduce EMI emissions and reduces power loss while preserving module functionality.

### SUMMARY OF THE INVENTION

The present invention is directed to an injector driver module having a first converter and a second converter connected between a power supply and the load. The first converter generates a first voltage output and the second converter generates a second voltage output. Switches control the connection between the first converter, the second converter, and the load so that the supply voltage applied to the load can be varied depending on an operational phase of the driver. More particularly, the switches connect a portion of the first converter either to the second voltage output or to ground to switch the supply voltage without switching actual supply lines

In one embodiment, both the first and the second converters are connected to the load so that a supply voltage to the load is the sum of the first and second output voltages during a magnetization phase. The high supply voltage quickly generates a peak current in the load. Once the peak current level has been reached, one of the converters is removed from the load to lower the supply voltage during a travel phase. During this stage, the voltage can be controlled to keep the current at a desired level. The current can then be lowered and later dropped to zero during hold and recuperation phases. Current control can be conducted through, for example, pulse width modulation. Lowering the supply voltage allows the pulse width modulation to be conducted at lower voltage levels, thereby lengthening the switching time during modulation, reducing power losses, and reducing EMI emissions.

The inventive module therefore adjusts the supply voltage level based on the operational phase of the module, allowing current control to be conducted via switching at lower voltages than previously known systems.

These and other features of the present invention can be best understood from the following specification and drawings, the following of which is a brief description.

### BRIEF DESCRIPTION OF THE DRAWINGS

FIG. 1 is a schematic illustrating a circuit for an injector driver module according to one embodiment of the invention;

FIGS. 2A and 2B are diagrams illustrating injector coil voltage and current waveforms according to one embodiment of the invention; and

FIG. 3 is a representative section view of a valve controlled by the injector driver module.

### DETAILED DESCRIPTION OF THE PREFERRED EMBODIMENT

The invention is directed to an injector driver module having a power supply and a load comprising one or more injector coils. Generally, a voltage across the injector coil is increased until current through the coil reaches a selected peak coil current level. Although the invention still conducts fast voltage transitions, it does so to a lesser extent and with increased switching times. The invention includes a novel power supply that can control the coil current in this manner. As a result, the invention generates fewer EMI emissions and reduces power losses in the module.

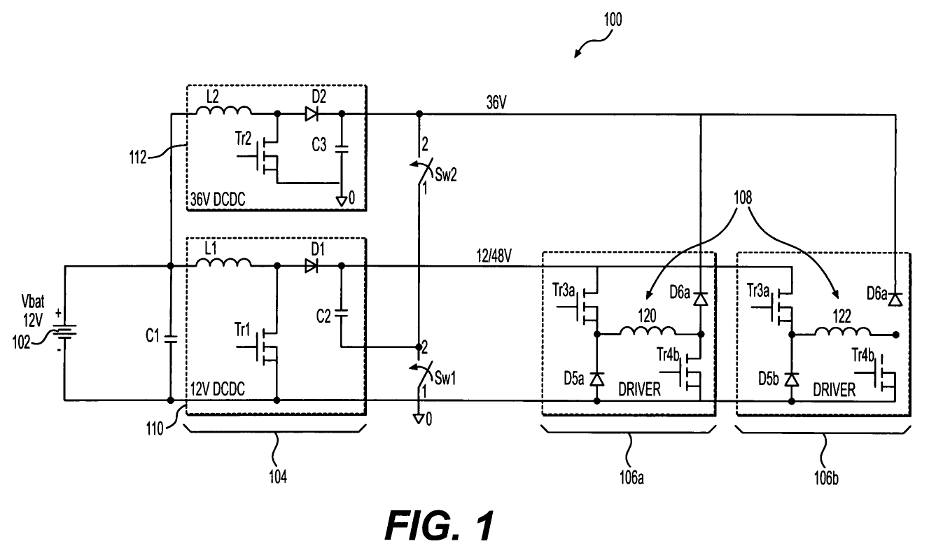

FIG. 1 illustrates an injector driver module 100 according to one embodiment of the invention. The module 100 is powered by any appropriate power source, such as a vehicle battery 102 (e.g., a 12V battery), and includes a power supply stage 104 and at least one driver stage having at least one injector coil load 108 that operates a fuel injector (not shown). The illustrated embodiment shows a module 100 having a first driver stage 106a with at least one opening coil 120 and a second driver stage 106b having at least one closing coil 122. The opening coil 120 and the closing coil 122 act as loads 108 in the module 100. The operation of the opening and closing coils 120, 122 will be described in greater detail below. Although the examples below mention specific voltage, current, and component values, those of skill in the art will understand that the module 100 can be implemented using other values without departing from the scope of the invention.

To avoid generating EMI emissions through high voltage switching of a 48V power supply generated by a 48V DC-DC converter, the power supply stage 104 includes a first DC-DC converter 110 and a second DC-DC converter 112, both of which are coupled to the vehicle battery 102. The first converter 110 generates a first output voltage that is lower than the high level needed to generate the peak coil current in the load 108. In the illustrated example, the first converter 110 generates a 12V output voltage from the battery voltage. Because the output voltage of the first converter 110 is the same as the battery voltage in this example, the first converter 110 will not operate as long as the voltage of the battery 102 remains high enough to provide sufficient voltage to the load 108 for operating an injector (not shown).

If the battery voltage drops to a low battery condition, storage components in the first converter 110 provide the load 108 with the voltage needed to operate the injector. In the illustrated example, the storage components in the first converter 110 include one or more capacitors and/or inductors. When the first converter 110 is not operating (i.e., if the battery voltage is high enough to supply voltage to the load 108), the first converter 110 may operate as a filter, such as a third order low pass filter, in the illustrated example.

The second converter 112 in the module 100 generates an output voltage that, when added with the output voltage of the first converter 110, is high enough to ensure that the current through the load 108 reaches a peak level quickly. In the illustrated example, the second converter 112 outputs 36V. The second converter 112 operates continuously and supplies an average current (e.g., 1A) and pulses of peak current (e.g., up to 20 A). In one embodiment, each peak current pulse lasts for only a short time period and is supplied by a storage device, such as a capacitor, that is replenished between current pulses.

Two switches SW1, SW2 selectively define the power supply voltage applied to the driver stage 106. The switches SW1, SW2 switch a low side of an output filter capacitor C2 in the first converter 110 between ground (when SW1 is closed) and 36V (when SW2 is closed). In one embodiment, the switches are operated in a break-before-make operation mode. The switches SW1, SW2 themselves can be any type of switch, such as a relay or CMOS field effect transistors, with SW1 being a low side switch and SW2 being a high side switch.

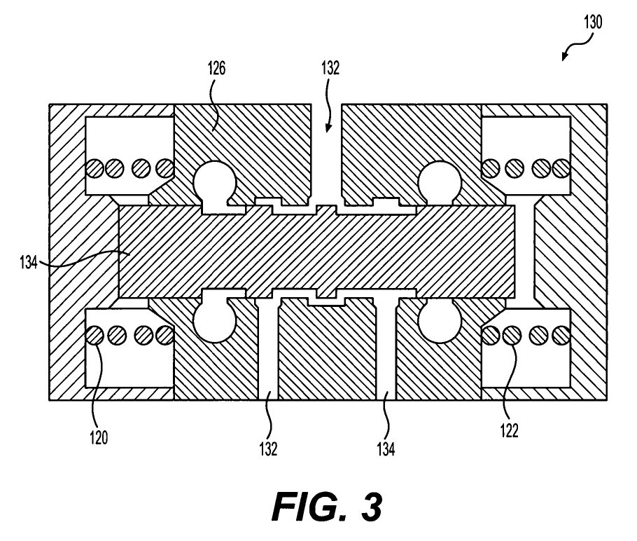

The load 108 may include a plurality of injector coils for operating a plurality of injector valves 130, shown in FIG. 3. The state of each valve 130 is controlled by an associated pair of coils 120, 122. The illustrated example assumes that the valves driven by the load 108 are not spring-loaded; therefore, the load 108 includes the opening coils 120 for opening their corresponding valves and the closing coils 122 for closing the valves. The coils 120, 122 may be divided into two separate groups so that the load 108 can continue operating valves associated with one group if the coils in the other group fail.

As shown in FIG. 3, a given pair of coils 120, 122 are disposed in a housing 126 of the valve 130. The valve 130 includes channels 132 through which fluid, such as fuel or hydraulic oil, can flow. A spool 134 within the housing 126 is movable between an open position and a closed position. More particularly, the spool 134 moves to the open position when the opening coil 120 is energized and the closing coil 122 is de-energized. Fluid flows through the channels 132 and out of the housing 126 when the spool 134 is in the open position until the opening coil 120 de-energizes and the closing coil 122 energizes to move the spool 134 to the closed position. A given pulse duration is defined as the travel time of the spool 134 when it moves between the open and closed position.

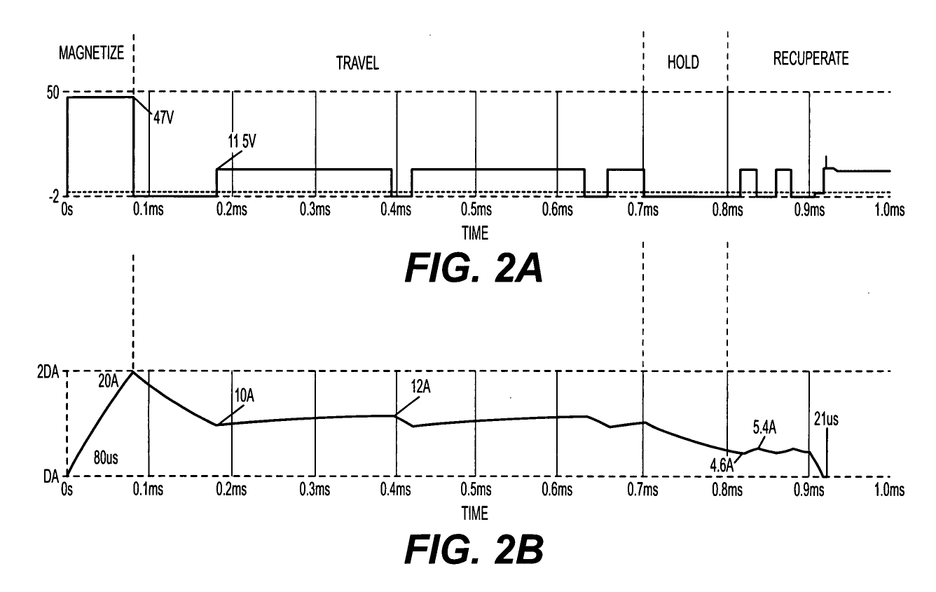

FIGS. 2A and 2B respectively illustrate examples of voltage and current waveforms for different phases of operation of the module 100. As is known in the art, the operation of the injector coils 104 is directly linked to operation of the power supply stage 104; thus, the power supply stage 104 operation is linked to the timing of the fuel injector.

During any given operation cycle of the module 100, the module 100 first operates in a magnetization phase 200. During this stage, SW1 is open and SW2 is closed, thereby linking the output voltages of both the first converter 110 and the second converter 112 to the load 108. In this case, the output filter capacitor C2 in the first converter 110 is connected to the output of the second converter 112. Thus, the supply voltage to the load 108 in the magnetization phase 200 is the sum of the output voltages of the first and second converters 110, 112 (i.e., 12V+36V=48V in this example). Supplying a high voltage to the load 108 at this stage ensures that the current in the load 108 ramps quickly up to a desired peak level (20A in this example, as shown in FIG. 2B). SW2 remains closed until the current in the load 108 reaches the peak level. This peak level current is selected to be large enough to move the spool 134 away from its current position.

After the current has reached the peak level, the module 100 then shifts to a travel phase 202 to allow the current in the load 108 to drop to a desired second level, such as 10A. Because the spool 134 is already in motion at this stage, the current no longer needs to stay at the peak level to maintain movement of the spool 134.

In this example, SW2 is opened and SW1 is closed so that only the output voltage of the first converter 110 (12V in this example) is sent to the load 108. In this case, the output filter capacitor C2 in the first converter 110 is connected to ground rather than to the output of the second converter 112. The output voltage of the first converter 110 is still high enough to provide enough current to operate the load 108, but with a lower number of pulse width modulated pulses and at a lower level (i.e., 12V pulses instead of 48V pulses).

The module 100 remains in the travel phase 202 until the spool 134 has reached its desired position in the housing 126. The module 100 then shifts to a hold phase 204, where the current to the load 108 is reduced to a third level. In the hold phase 204, the spool 134 no longer needs to be moved, so the current can be lowered even further to a level sufficient to hold the spool 134 in place until all the mechanical energy from the impact of the spool 134 has ceased. The current level may then be dropped to zero. The spool 134 may then be kept in position by magnetic remanence for a desired duration corresponding to the amount of fluid desired per injection cycle. The opening coil 120 and the closing coil 122 are activated in the same manner depending on whether fluid flow is to be permitted or terminated.

In both the travel phase 202 and the hold phase 204, the current level may be controlled via pulse width modulation. However, the pulse width modulated switching in the inventive module 100 is conducted at a lower voltage and current amplitude than previously known modules (e.g., at 12V rather than at 48V, and at 10 A and 5 A rather than 20 A). Thus, the switching times can be increased and also conducted with less power.

The module 100 then enters a recuperation phase 206 where the driver switches Tr3a and Tr4a associated with the opening coil 120 and switches Tr3b and Tr4b associated with the closing coil 122 are all turned off. This causes the stored magnetic energy in the coils 120, 122 to flow through the diodes D3a, D3b, D4a, and D4b in the driver stage 106 back to the second converter 112, restoring charge to an output filter capacitor C3 in the second converter 112. This causes the current in the load 108 to rapidly drop to zero, fully de-energizing the load 108. The cycle then can restart with the magnetization phase 200 in other selected coils to move the spool 134 back to the other side of the housing 126 (i.e., to the closed position if the spool 134 is in the open position and to the open position if the spool 134 is in the closed position).

Note that the module 100 can select voltage levels other than the ones described above to control the amount of current through the load 108. For example, the module 100 may use 48V to obtain the peak current to start spool movement during the magnetization phase 200, drop to 24V during the travel phase 202, and drop again to 12V during the hold phase 204 and the recuperation phase 206. Those of skill in the art will be able to determine how to set the converters 110, 112 at other levels to carry out the voltage and current control in the module 100 without departing from the scope of the invention.

By energizing either the opening coils 120 or the closing coils 122 to move the spool 134 to the open position and the closed position, respectively, the inventive module 100 can provide precise injection control without requiring switching of a high voltage device. Rather than relying on a peak voltage level for the entire operation of the spool 134, the inventive module 100 customizes the current flow through the load 108 and lowers the voltage level sent to the load 108 to the lowest level needed to carry out the function of the driver 106 at a given operational phase. More particularly, the invention is able to switch the supply voltage to the load 108 without switching the supply lines themselves by selectively connecting an output filter capacitor in the first converter to either the output of the second converter or to ground.

Reducing the switching voltage amplitude and increasing the switching time reduces EMI radiated emissions generated by the switching to much lower levels. Moreover, the lower power needed to conduct the switching reduces power losses and allow lower power components to be used in the converters 110, 112. Eliminating the need for expensive high power components in the module 100 allows the module 100 to be constructed with simpler mechanics and reduced cost.

It should be understood that various alternatives to the embodiments of the invention described herein may be employed in practicing the invention. It is intended that the following claims define the scope of the invention and that the method and apparatus within the scope of these claims and their equivalents be covered thereby.

1. An injector driver module, comprising:
a first converter that generates a first voltage output;
a second converter that generates a second voltage output, wherein the first converter and the second converter are connectable to a power source;
a load having at least one driver coil; and
at least one switch that selectively connects a portion of the first converter to ground and to the second voltage output to vary a supply voltage applied to the load.

2. The module of claim 1, wherein the portion of the first converter comprises a first output filter capacitor, and wherein said at least one switch connects a first side of the first output filter capacitor to the second voltage output to apply a first supply voltage during a magnetization phase to generate a peak current through the load.

3. The module of claim 2, wherein said at least one switch connects the first side of the first output filter capacitor to ground during a travel phase to apply a second supply voltage, wherein the second supply voltage is lower than the first supply voltage.

4. The module of claim 3, wherein said at least one switch varies a load current through the load such that the module generates a first load current during the travel phase and a second load current lower than the first load current during a hold phase.

5. The module of claim 4, wherein said at least one switch varies the load current via pulse width modulation.

6. The module of claim 2, wherein the second converter includes a second output filter capacitor, and wherein the module further comprises at least one driver switch that is controlled to drain stored energy in the load toward the second output filter capacitor during a recuperation phase.

7. The module of claim 1, wherein said at least one coil comprises at least one opening coil associated with an open valve position and at least one closing coil associated with a closed valve position.

8. A fuel injection system for a vehicle, comprising:
a first converter that generates a first output voltage;
a second converter that generates a second output voltage, wherein the first converter and the second converter are connectable to a vehicle battery;
at least one valve that controls fuel flow;
a load having at least one opening coil associated with an open valve position and at least one closing coil associated with a closed valve position, wherein valve is controllable by one opening coil and one closing coil; and
at least one switch that selectively connects a portion of the first converter to ground and to the second voltage output to vary a supply voltage applied to the load.

9. The system of claim 8, wherein the portion of the first converter comprises a first output filter capacitor, and wherein said at least one switch connects a first side of the first output filter capacitor to the second voltage output to apply a first supply voltage during a magnetization phase to generate a peak current through the load.

10. The system of claim 9, wherein said at least one switch connects the first side of the first output filter capacitor to ground during a travel phase to apply a second supply voltage, wherein the second supply voltage is lower than the first supply voltage.

11. The system of claim 10, wherein said at least one switch varies a load current through the load such that the module generates a first load current during the travel phase and a second load current lower than the first load current during a hold phase.

12. The system of claim 11, wherein said at least one switch varies the load current via pulse width modulation.

13. The system of claim 9, wherein the second converter includes a second output filter capacitor, and wherein the module further comprises at least one driver switch that is controlled to drain stored energy in the load toward the second output filter capacitor during a recuperation phase.

14. A method of controlling a valve in a fluid injector, comprising:
generating a first voltage output of a first converter;
generating a second voltage output of a second converter; and
selectively connecting a portion of the first converter to ground and to the second output voltage to vary a supply voltage and a current to a load.

15. The method of claim 14, wherein the portion of the first converter comprises a first output filter capacitor, and wherein the selectively connecting step comprises connecting a first side of the first output filter capacitor to the second voltage output of the second converter to apply a first supply voltage during a magnetization phase to generate a peak current through the load.

16. The method of claim 15, wherein the selectively connecting step further comprises connecting the first side of the first output filter capacitor to ground during a travel phase to apply a second supply voltage, wherein the second supply voltage is lower than the first supply voltage.

17. The method of claim 16, further comprising the step of varying a load current through the load such that the module generates a first load current during the travel phase and a second load current lower than the first load current during a hold phase.

18. The method of claim 15, wherein the second converter includes a second output filter capacitor, and wherein the method further comprises draining stored energy in the load toward the second output filter capacitor during a recuperation phase.
